(19) United States
(12) Patent Application Publication
(10) Pub. No.: US 2025/0190804 A1
(43) Pub. Date: Jun. 12, 2025

(54) System, Method, and Computer Program Product for Active Learning in Graph Neural Networks Through Hybrid Uncertainty Reduction

(71) Applicant: Visa International Service Association, San Francisco, CA (US)

(72) Inventors: Xiaoting Li, Sunnyvale, CA (US); Yuhang Wu, Jersey City, NJ (US); Yu-San Lin, San Francisco, CA (US); Fei Wang, Fremont, CA (US)

(21) Appl. No.: 18/845,914

(22) PCT Filed: Mar. 21, 2023
(86) PCT No.: PCT/US23/15710

§ 371 Date: Sep. 11, 2024

Related U.S. Application Data
(60) Provisional application No. 63/338,089, filed on May 4, 2022.

(51) Int. Cl. G06N 3/0895; G06N 3/042

(52) U.S. Cl. CPC G06N 3/0895; G06N 3/042

(57) ABSTRACT

Systems, methods, and computer program products may (i) obtain a graph including a plurality of edges and a plurality of nodes for the plurality of edges, each labeled node of a subset of labeled nodes being associated with a label, and each unlabeled node of a subset of unlabeled nodes not being associated with a label; (ii) train, using the graph and the label for each labeled node, a graph neural network (GNN), wherein training the GNN generates a prediction for each node; (iii) generate, from the subset of unlabeled nodes, a candidate pool of candidate nodes; (iv) generate, using a label propagation algorithm, a predicted label for each candidate node; (v) select a candidate node of the candidate pool of candidate nodes that is associated with a greatest hybrid entropy reduction for the graph; and (vi) provide the selected candidate node for labeling.

### CROSS REFERENCE TO RELATED APPLICATIONS

This application is the United States national phase of International Patent Application No. PCT/US23/15710 filed on Mar. 21, 2023, and claims the benefit of U.S. Provisional Patent Application No. 63/338,089, filed on May 4, 2022, the disclosures of which are hereby incorporated by reference in their entireties.

### BACKGROUND

### 1. Technical Field

This disclosure relates to active learning in graph neural networks and, in some non-limiting embodiments or aspects, to active learning in graph neural networks through hybrid uncertainty reduction.

### 2. Technical Considerations

Graphs are a powerful tool to learn knowledge from network data, where nodes denote instances that may be characterized by rich attributes, and edges encode relationships between nodes. However, gathering a sufficient amount of labeled data may be expensive and time-consuming, which adds a challenge to the expansion of graph neural networks towards security-critical fields, such as anomaly detection and/or the like. For example, data for many real-world scenarios do not have enough labels, which makes these scenarios hard to model as supervised problems. Moreover, many existing studies focus on independent and identically distributed data scenarios and are not designed for networked data. Selection of nodes for labeling to maximize the performance of graph models is also not trivial, because different sets of training nodes may lead to very different graph representation results. Accordingly, there is a need to leverage active learning to dynamically query labels of the most informative instances from unlabeled data to tackle the data shortage challenge in graphs.

### SUMMARY

Accordingly, provided are improved systems, devices, products, apparatus, and/or methods for active learning in graph neural networks through hybrid uncertainty reduction.

According to some non-limiting embodiments or aspects, provided is a computer-implemented method, including: (i) obtaining, with at least one processor, a graph including a plurality of edges and a plurality of nodes for the plurality of edges, wherein each labeled node of a subset of labeled nodes of the plurality of nodes is associated with a label, and wherein each unlabeled node of a subset of unlabeled nodes of the plurality of nodes is not associated with a label; (ii) training, with the at least one processor, using the graph and the label for each labeled node of the subset of labeled nodes, a graph neural network (GNN), wherein training the GNN generates a prediction for each node of the plurality of nodes; (iii) generating, with the at least one processor, from the subset of unlabeled nodes, a candidate pool of candidate nodes; (iv) generating, with the at least one processor, using a label propagation algorithm, a predicted label for each candidate node of the candidate pool of candidate nodes; (v) selecting, with the at least one processor, a candidate node of the candidate pool of candidate nodes that is associated with a greatest hybrid entropy reduction for the graph, wherein a current entropy of the graph is determined based on the prediction for each node of the plurality of nodes, wherein, for each candidate node of the candidate pool of candidate nodes, an updated entropy of the graph is determined based on the predicted label for that candidate node, and wherein, for each candidate node of the candidate pool of candidate nodes, a hybrid entropy reduction for the graph is determined as a difference between the current entropy of the graph and the updated entropy of the graph determined for that candidate node; (vi) providing, with the at least one processor, the selected candidate node for labeling; (vii) receiving, with the at least one processor, a new label associated with the selected candidate node; (viii) adding, with the at least one processor, the selected candidate node to the subset of labeled nodes as a labeled node associated with the new label; and (ix) retraining, with the at least one processor, using the graph and the label for each labeled node of the subset of labeled nodes including the selected candidate node added to the subset of labeled nodes as a labeled node associated with the new label, the GNN, wherein retraining the GNN regenerates the prediction for each node of the plurality of nodes.

In some non-limiting embodiments or aspects, the method further includes: repeating, with the at least one processor, steps (iii)-(ix) a budgeted number of times.

In some non-limiting embodiments or aspects, the method further includes: after repeating the steps (iii)-(ix) the budgeted number of times, providing the retrained GNN; receiving, with the at least one processor, a further graph including a plurality of further edges and a plurality of further nodes for the plurality of further edges; processing, with the at least one processor, using the retrained GNN, the further graph by providing, as input to the GNN, the further graph, and receiving, as output from the GNN, a further prediction for each further node of the plurality of further nodes; and identifying, with the at least one processor, based on the further prediction for each further node of the plurality of further nodes, a further node of the plurality of further nodes as an anomalous node.

In some non-limiting embodiments or aspects, the plurality of further nodes is associated with a plurality of merchants, and wherein a merchant associated with the further node is identified as a default risk.

In some non-limiting embodiments or aspects, the method further includes: in response to identifying the merchant as a default risk, at least one of: (i) automatically transmitting, with the at least one processor, information associated with an account of the merchant to a database to flag the account as associated with the default risk; (ii) automatically suspending, with the at least one processor, processing of a transaction associated with the merchant in a transaction processing network by canceling the transaction; (iii) automatically suspending, with the at least one processor, access of the account of the merchant to a transaction service provider system in the transaction processing network; or any combination thereof.

In some non-limiting embodiments or aspects, generating, from the subset of unlabeled nodes, the candidate pool of candidate nodes includes at least one of the following: (i) clustering the subset of unlabeled nodes into a plurality of clusters of unlabeled nodes and selecting, from each cluster of the plurality of clusters, for the candidate pool of candidate nodes, unlabeled nodes within a threshold distance of a center of that cluster; (ii) calculating, based on the graph, a graph centrality of each unlabeled node of the subset of unlabeled nodes and selecting, for the candidate pool of candidate nodes, the unlabeled nodes associated with a graph centrality that satisfies a threshold graph centrality; (iii) generating, using the label propagation algorithm, the predicted label for each unlabeled node of the subset of unlabeled nodes, comparing, for each unlabeled node, the predicted label for that unlabeled node to the prediction for that node, and selecting, for the candidate pool of candidate nodes, the unlabeled nodes associated with a disagreement between the predicted label and the prediction; or any combination thereof.

In some non-limiting embodiments or aspects, the GNN includes a graph convolutional network (GCN).

According to some non-limiting embodiments or aspects, provided is a system, including: at least one processor programmed and/or configured to: (i) obtain a graph including a plurality of edges and a plurality of nodes for the plurality of edges, wherein each labeled node of a subset of labeled nodes of the plurality of nodes is associated with a label, and wherein each unlabeled node of a subset of unlabeled nodes of the plurality of nodes is not associated with a label; (ii) train, using the graph and the label for each labeled node of the subset of labeled nodes, a graph neural network (GNN), wherein training the GNN generates a prediction for each node of the plurality of nodes; (iii) generate, from the subset of unlabeled nodes, a candidate pool of candidate nodes; (iv) generate, using a label propagation algorithm, a predicted label for each candidate node of the candidate pool of candidate nodes; (v) select a candidate node of the candidate pool of candidate nodes that is associated with a greatest hybrid entropy reduction for the graph, wherein a current entropy of the graph is determined based on the prediction for each node of the plurality of nodes, wherein, for each candidate node of the candidate pool of candidate nodes, an updated entropy of the graph is determined based on the predicted label for that candidate node, and wherein, for each candidate node of the candidate pool of candidate nodes, a hybrid entropy reduction for the graph is determined as a difference between the current entropy of the graph and the updated entropy of the graph determined for that candidate node; (vi) provide the selected candidate node for labeling; (vii) receive a new label associated with the selected candidate node; (viii) add the selected candidate node to the subset of labeled nodes as a labeled node associated with the new label; and (ix) retrain, using the graph and the label for each labeled node of the subset of labeled nodes including the selected candidate node added to the subset of labeled nodes as a labeled node associated with the new label, the GNN, wherein retraining the GNN regenerates the prediction for each node of the plurality of nodes.

In some non-limiting embodiments or aspects, the at least one processor is further programmed and/or configured to: repeat steps (iii)-(ix) a budgeted number of times.

In some non-limiting embodiments or aspects, the at least one processor is further programmed and/or configured to: after repeating the steps (iii)-(ix) the budgeted number of times, provide the retrained GNN; receive a further graph including a plurality of further edges and a plurality of further nodes for the plurality of further edges; process, using the retrained GNN, the further graph by providing, as input to the GNN, the further graph, and receiving, as output from the GNN, a further prediction for each further node of the plurality of further nodes; and identify, based on the further prediction for each further node of the plurality of further nodes, a further node of the plurality of further nodes as an anomalous node.

In some non-limiting embodiments or aspects, the plurality of further nodes is associated with a plurality of merchants, and wherein a merchant associated with the further node is identified as a default risk.

In some non-limiting embodiments or aspects, the at least one processor is further programmed and/or configured to: in response to identifying the merchant as a default risk, at least one of: (i) automatically transmit information associated with an account of the merchant to a database to flag the account as associated with the default risk; (ii) automatically suspend processing of a transaction associated with the merchant in a transaction processing network by canceling the transaction; (iii) automatically suspend access of the account of the merchant to a transaction service provider system in the transaction processing network; or any combination thereof.

In some non-limiting embodiments or aspects, the at least one processor is programmed and/or configured to generate, from the subset of unlabeled nodes, the candidate pool of candidate nodes by at least one of the following: (i) clustering the subset of unlabeled nodes into a plurality of clusters of unlabeled nodes and selecting, from each cluster of the plurality of clusters, for the candidate pool of candidate nodes, unlabeled nodes within a threshold distance of a center of that cluster; (ii) calculating, based on the graph, a graph centrality of each unlabeled node of the subset of unlabeled nodes and selecting, for the candidate pool of candidate nodes, the unlabeled nodes associated with a graph centrality that satisfies a threshold graph centrality; (iii) generating, using the label propagation algorithm, the predicted label for each unlabeled node of the subset of unlabeled nodes, comparing, for each unlabeled node, the predicted label for that unlabeled node to the prediction for that node, and selecting, for the candidate pool of candidate nodes, the unlabeled nodes associated with a disagreement between the predicted label and the prediction; or any combination thereof.

In some non-limiting embodiments or aspects, the GNN includes a graph convolutional network (GCN).

According to some non-limiting embodiments or aspects, provided is a computer program product comprising at least one non-transitory computer-readable medium including program instructions that, when executed by at least one processor, cause the at least one processor to: (i) obtain a graph including a plurality of edges and a plurality of nodes for the plurality of edges, wherein each labeled node of a subset of labeled nodes of the plurality of nodes is associated with a label, and wherein each unlabeled node of a subset of unlabeled nodes of the plurality of nodes is not associated with a label; (ii) train, using the graph and the label for each labeled node of the subset of labeled nodes, a graph neural network (GNN), wherein training the GNN generates a prediction for each node of the plurality of nodes; (iii) generate, from the subset of unlabeled nodes, a candidate pool of candidate nodes; (iv) generate, using a label propagation algorithm, a predicted label for each candidate node of the candidate pool of candidate nodes; (v) select a candidate node of the candidate pool of candidate nodes that is associated with a greatest hybrid entropy reduction for the graph, wherein a current entropy of the graph is determined based on the prediction for each node of the plurality of nodes, wherein, for each candidate node of the candidate pool of candidate nodes, an updated entropy of the graph is determined based on the predicted label for that candidate node, and wherein, for each candidate node of the candidate pool of candidate nodes, a hybrid entropy reduction for the graph is determined as a difference between the current entropy of the graph and the updated entropy of the graph determined for that candidate node; (vi) provide the selected candidate node for labeling; (vii) receive a new label associated with the selected candidate node; (viii) add the selected candidate node to the subset of labeled nodes as a labeled node associated with the new label; and (ix) retrain, using the graph and the label for each labeled node of the subset of labeled nodes including the selected candidate node added to the subset of labeled nodes as a labeled node associated with the new label, the GNN, wherein retraining the GNN regenerates the prediction for each node of the plurality of nodes.

In some non-limiting embodiments or aspects, the program instructions, when executed by the at least one processor, further cause the at least one processor to: repeat steps (iii)-(ix) a budgeted number of times.

In some non-limiting embodiments or aspects, the program instructions, when executed by the at least one processor, further cause the at least one processor to: after repeating the steps (iii)-(ix) the budgeted number of times, provide the retrained GNN; receive a further graph including a plurality of further edges and a plurality of further nodes for the plurality of further edges; process, using the retrained GNN, the further graph by providing, as input to the GNN, the further graph, and receiving, as output from the GNN, a further prediction for each further node of the plurality of further nodes; and identify, based on the further prediction for each further node of the plurality of further nodes, a further node of the plurality of further nodes as an anomalous node.

In some non-limiting embodiments or aspects, the plurality of further nodes is associated with a plurality of merchants, and wherein a merchant associated with the further node is identified as a default risk.

In some non-limiting embodiments or aspects, the program instructions, when executed by the at least one processor, further cause the at least one processor to: in response to identifying the merchant as a default risk, at least one of: (i) automatically transmit information associated with an account of the merchant to a database to flag the account as associated with the default risk; (ii) automatically suspend processing of a transaction associated with the merchant in a transaction processing network by canceling the transaction; (iii) automatically suspend access of the account of the merchant to a transaction service provider system in the transaction processing network; or any combination thereof.

In some non-limiting embodiments or aspects, the program instructions, when executed by the at least one processor, cause the at least one processor to generate, from the subset of unlabeled nodes, the candidate pool of candidate nodes by at least one of the following: (i) clustering the subset of unlabeled nodes into a plurality of clusters of unlabeled nodes and selecting, from each cluster of the plurality of clusters, for the candidate pool of candidate nodes, unlabeled nodes within a threshold distance of a center of that cluster; (ii) calculating, based on the graph, a graph centrality of each unlabeled node of the subset of unlabeled nodes and selecting, for the candidate pool of candidate nodes, the unlabeled nodes associated with a graph centrality that satisfies a threshold graph centrality; (iii) generating, using the label propagation algorithm, the predicted label for each unlabeled node of the subset of unlabeled nodes, comparing, for each unlabeled node, the predicted label for that unlabeled node to the prediction for that node, and selecting, for the candidate pool of candidate nodes, the unlabeled nodes associated with a disagreement between the predicted label and the prediction; or any combination thereof.

Further non-limiting embodiments or aspects are set forth in the following numbered clauses:

Clause 1. A computer-implemented method, comprising: (i) obtaining, with at least one processor, a graph including a plurality of edges and a plurality of nodes for the plurality of edges, wherein each labeled node of a subset of labeled nodes of the plurality of nodes is associated with a label, and wherein each unlabeled node of a subset of unlabeled nodes of the plurality of nodes is not associated with a label; (ii) training, with the at least one processor, using the graph and the label for each labeled node of the subset of labeled nodes, a graph neural network (GNN), wherein training the GNN generates a prediction for each node of the plurality of nodes; (iii) generating, with the at least one processor, from the subset of unlabeled nodes, a candidate pool of candidate nodes; (iv) generating, with the at least one processor, using a label propagation algorithm, a predicted label for each candidate node of the candidate pool of candidate nodes; (v) selecting, with the at least one processor, a candidate node of the candidate pool of candidate nodes that is associated with a greatest hybrid entropy reduction for the graph, wherein a current entropy of the graph is determined based on the prediction for each node of the plurality of nodes, wherein, for each candidate node of the candidate pool of candidate nodes, an updated entropy of the graph is determined based on the predicted label for that candidate node, and wherein, for each candidate node of the candidate pool of candidate nodes, a hybrid entropy reduction for the graph is determined as a difference between the current entropy of the graph and the updated entropy of the graph determined for that candidate node; (vi) providing, with the at least one processor, the selected candidate node for labeling; (vii) receiving, with the at least one processor, a new label associated with the selected candidate node; (viii) adding, with the at least one processor, the selected candidate node to the subset of labeled nodes as a labeled node associated with the new label; and (ix) retraining, with the at least one processor, using the graph and the label for each labeled node of the subset of labeled nodes including the selected candidate node added to the subset of labeled nodes as a labeled node associated with the new label, the GNN, wherein retraining the GNN regenerates the prediction for each node of the plurality of nodes.

Clause 2. The computer-implemented method of clause 1, further comprising: repeating, with the at least one processor, steps (iii)-(ix) a budgeted number of times.

Clause 3. The computer-implemented method of clauses 1 or 2, further comprising: after repeating the steps (iii)-(ix) the budgeted number of times, providing the retrained GNN; receiving, with the at least one processor, a further graph including a plurality of further edges and a plurality of further nodes for the plurality of further edges; processing, with the at least one processor, using the retrained GNN, the further graph by providing, as input to the GNN, the further graph, and receiving, as output from the GNN, a further prediction for each further node of the plurality of further nodes; and identifying, with the at least one processor, based on the further prediction for each further node of the plurality of further nodes, a further node of the plurality of further nodes as an anomalous node.

Clause 4. The computer-implemented method of any of clauses 1-3, wherein the plurality of further nodes is associated with a plurality of merchants, and wherein a merchant associated with the further node is identified as a default risk.

Clause 5. The computer-implemented method of any of clauses 1-4, further comprising: in response to identifying the merchant as a default risk, at least one of: (i) automatically transmitting, with the at least one processor, information associated with an account of the merchant to a database to flag the account as associated with the default risk; (ii) automatically suspending, with the at least one processor, processing of a transaction associated with the merchant in a transaction processing network by canceling the transaction; (iii) automatically suspending, with the at least one processor, access of the account of the merchant to a transaction service provider system in the transaction processing network; or any combination thereof.

Clause 6. The computer-implemented method of any of clauses 1-5, wherein generating, from the subset of unlabeled nodes, the candidate pool of candidate nodes includes at least one of the following: (i) clustering the subset of unlabeled nodes into a plurality of clusters of unlabeled nodes and selecting, from each cluster of the plurality of clusters, for the candidate pool of candidate nodes, unlabeled nodes within a threshold distance of a center of that cluster; (ii) calculating, based on the graph, a graph centrality of each unlabeled node of the subset of unlabeled nodes and selecting, for the candidate pool of candidate nodes, the unlabeled nodes associated with a graph centrality that satisfies a threshold graph centrality; (iii) generating, using the label propagation algorithm, the predicted label for each unlabeled node of the subset of unlabeled nodes, comparing, for each unlabeled node, the predicted label for that unlabeled node to the prediction for that node, and selecting, for the candidate pool of candidate nodes, the unlabeled nodes associated with a disagreement between the predicted label and the prediction; or any combination thereof.

Clause 7. The computer-implemented method of any of clauses 1-6, wherein the GNN includes a graph convolutional network (GCN).

Clause 8. A system, comprising: at least one processor programmed and/or configured to: (i) obtain a graph including a plurality of edges and a plurality of nodes for the plurality of edges, wherein each labeled node of a subset of labeled nodes of the plurality of nodes is associated with a label, and wherein each unlabeled node of a subset of unlabeled nodes of the plurality of nodes is not associated with a label; (ii) train, using the graph and the label for each labeled node of the subset of labeled nodes, a graph neural network (GNN), wherein training the GNN generates a prediction for each node of the plurality of nodes; (iii) generate, from the subset of unlabeled nodes, a candidate pool of candidate nodes; (iv) generate, using a label propagation algorithm, a predicted label for each candidate node of the candidate pool of candidate nodes; (v) select a candidate node of the candidate pool of candidate nodes that is associated with a greatest hybrid entropy reduction for the graph, wherein a current entropy of the graph is determined based on the prediction for each node of the plurality of nodes, wherein, for each candidate node of the candidate pool of candidate nodes, an updated entropy of the graph is determined based on the predicted label for that candidate node, and wherein, for each candidate node of the candidate pool of candidate nodes, a hybrid entropy reduction for the graph is determined as a difference between the current entropy of the graph and the updated entropy of the graph determined for that candidate node; (vi) provide the selected candidate node for labeling; (vii) receive a new label associated with the selected candidate node; (viii) add the selected candidate node to the subset of labeled nodes as a labeled node associated with the new label; and (ix) retrain, using the graph and the label for each labeled node of the subset of labeled nodes including the selected candidate node added to the subset of labeled nodes as a labeled node associated with the new label, the GNN, wherein retraining the GNN regenerates the prediction for each node of the plurality of nodes.

Clause 9. The system of clause 8, wherein the at least one processor is further programmed and/or configured to: repeat steps (iii)-(ix) a budgeted number of times.

Clause 10. The system of clauses 8 or 9, wherein the at least one processor is further programmed and/or configured to: after repeating the steps (iii)-(ix) the budgeted number of times, provide the retrained GNN; receive a further graph including a plurality of further edges and a plurality of further nodes for the plurality of further edges; process, using the retrained GNN, the further graph by providing, as input to the GNN, the further graph, and receiving, as output from the GNN, a further prediction for each further node of the plurality of further nodes; and identify, based on the further prediction for each further node of the plurality of further nodes, a further node of the plurality of further nodes as an anomalous node.

Clause 11. The system of any of clauses 8-10, wherein the plurality of further nodes is associated with a plurality of merchants, and wherein a merchant associated with the further node is identified as a default risk.

Clause 12. The system of any of clauses 8-11, wherein the at least one processor is further programmed and/or configured to: in response to identifying the merchant as a default risk, at least one of: (i) automatically transmit information associated with an account of the merchant to a database to flag the account as associated with the default risk; (ii) automatically suspend processing of a transaction associated with the merchant in a transaction processing network by canceling the transaction; (iii) automatically suspend access of the account of the merchant to a transaction service provider system in the transaction processing network; or any combination thereof.

Clause 13. The system of any of clauses 8-12, wherein the at least one processor is programmed and/or configured to generate, from the subset of unlabeled nodes, the candidate pool of candidate nodes by at least one of the following: (i) clustering the subset of unlabeled nodes into a plurality of clusters of unlabeled nodes and selecting, from each cluster of the plurality of clusters, for the candidate pool of candidate nodes, unlabeled nodes within a threshold distance of a center of that cluster; (ii) calculating, based on the graph, a graph centrality of each unlabeled node of the subset of unlabeled nodes and selecting, for the candidate pool of candidate nodes, the unlabeled nodes associated with a graph centrality that satisfies a threshold graph centrality; (iii) generating, using the label propagation algorithm, the predicted label for each unlabeled node of the subset of unlabeled nodes, comparing, for each unlabeled node, the predicted label for that unlabeled node to the prediction for that node, and selecting, for the candidate pool of candidate nodes, the unlabeled nodes associated with a disagreement between the predicted label and the prediction; or any combination thereof.

Clause 14. The system of any of clauses 8-13, wherein the GNN includes a graph convolutional network (GCN).

Clause 15. A computer program product comprising at least one non-transitory computer-readable medium including program instructions that, when executed by at least one processor, cause the at least one processor to: (i) obtain a graph including a plurality of edges and a plurality of nodes for the plurality of edges, wherein each labeled node of a subset of labeled nodes of the plurality of nodes is associated with a label, and wherein each unlabeled node of a subset of unlabeled nodes of the plurality of nodes is not associated with a label; (ii) train, using the graph and the label for each labeled node of the subset of labeled nodes, a graph neural network (GNN), wherein training the GNN generates a prediction for each node of the plurality of nodes; (iii) generate, from the subset of unlabeled nodes, a candidate pool of candidate nodes; (iv) generate, using a label propagation algorithm, a predicted label for each candidate node of the candidate pool of candidate nodes; (v) select a candidate node of the candidate pool of candidate nodes that is associated with a greatest hybrid entropy reduction for the graph, wherein a current entropy of the graph is determined based on the prediction for each node of the plurality of nodes, wherein, for each candidate node of the candidate pool of candidate nodes, an updated entropy of the graph is determined based on the predicted label for that candidate node, and wherein, for each candidate node of the candidate pool of candidate nodes, a hybrid entropy reduction for the graph is determined as a difference between the current entropy of the graph and the updated entropy of the graph determined for that candidate node; (vi) provide the selected candidate node for labeling; (vii) receive a new label associated with the selected candidate node; (viii) add the selected candidate node to the subset of labeled nodes as a labeled node associated with the new label; and (ix) retrain, using the graph and the label for each labeled node of the subset of labeled nodes including the selected candidate node added to the subset of labeled nodes as a labeled node associated with the new label, the GNN, wherein retraining the GNN regenerates the prediction for each node of the plurality of nodes.

Clause 16. The computer program product of clause 15, wherein the program instructions, when executed by the at least one processor, further cause the at least one processor to: repeat steps (iii)-(ix) a budgeted number of times.

Clause 17. The computer program product of clauses 15 or 16, wherein the program instructions, when executed by the at least one processor, further cause the at least one processor to: after repeating the steps (iii)-(ix) the budgeted number of times, provide the retrained GNN; receive a further graph including a plurality of further edges and a plurality of further nodes for the plurality of further edges; process, using the retrained GNN, the further graph by providing, as input to the GNN, the further graph, and receiving, as output from the GNN, a further prediction for each further node of the plurality of further nodes; and identify, based on the further prediction for each further node of the plurality of further nodes, a further node of the plurality of further nodes as an anomalous node.

Clause 18. The computer program product of any of clauses 15-17, wherein the plurality of further nodes is associated with a plurality of merchants, and wherein a merchant associated with the further node is identified as a default risk.

Clause 19. The computer program product of any of clauses 15-18, wherein the program instructions, when executed by the at least one processor, further cause the at least one processor to: in response to identifying the merchant as a default risk, at least one of: (i) automatically transmit information associated with an account of the merchant to a database to flag the account as associated with the default risk; (ii) automatically suspend processing of a transaction associated with the merchant in a transaction processing network by canceling the transaction; (iii) automatically suspend access of the account of the merchant to a transaction service provider system in the transaction processing network; or any combination thereof.

Clause 20. The computer program product of any of clauses 15-19, wherein the program instructions, when executed by the at least one processor, cause the at least one processor to generate, from the subset of unlabeled nodes, the candidate pool of candidate nodes by at least one of the following: (i) clustering the subset of unlabeled nodes into a plurality of clusters of unlabeled nodes and selecting, from each cluster of the plurality of clusters, for the candidate pool of candidate nodes, unlabeled nodes within a threshold distance of a center of that cluster; (ii) calculating, based on the graph, a graph centrality of each unlabeled node of the subset of unlabeled nodes and selecting, for the candidate pool of candidate nodes, the unlabeled nodes associated with a graph centrality that satisfies a threshold graph centrality; (iii) generating, using the label propagation algorithm, the predicted label for each unlabeled node of the subset of unlabeled nodes, comparing, for each unlabeled node, the predicted label for that unlabeled node to the prediction for that node, and selecting, for the candidate pool of candidate nodes, the unlabeled nodes associated with a disagreement between the predicted label and the prediction; or any combination thereof.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of limits. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments that are illustrated in the accompanying schematic figures, in which:

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIGS. 3A-3C are a flowchart of non-limiting embodiments or aspects of a process for active learning in graph neural networks through hybrid uncertainty reduction; and

FIG. 4 is a diagram of an implementation of non-limiting embodiments or aspects of a process for active learning in graph neural networks through hybrid uncertainty reduction.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

It will be apparent that systems and/or methods, described herein, can be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computing devices operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases and/or the like) such that they may be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a PAN, to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides goods and/or services, or access to goods and/or services, to users (e.g. customers) based on a transaction (e.g. a payment transaction). As used herein, the terms “merchant” or “merchant system” may also refer to one or more computer systems, computing devices, and/or software application operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The terms “client device” and “user device,” as used herein, refer to any electronic device that is configured to communicate with one or more servers or remote devices and/or systems. A client device or user device may include a mobile device, a network-enabled appliance (e.g., a network-enabled television, refrigerator, thermostat, and/or the like), a computer, a POS system, and/or any other device or system capable of communicating with a network.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “payment device” may refer to a portable financial device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computer, an access card, a wireless terminal, a transponder, and/or the like. In some non-limiting embodiments or aspects, the payment device may include volatile or nonvolatile memory to store information (e.g., an account identifier, a name of the account holder, and/or the like).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the term “application programming interface” (API) may refer to computer code that allows communication between different systems or (hardware and/or software) components of systems. For example, an API may include function calls, functions, subroutines, communication protocols, fields, and/or the like usable and/or accessible by other systems or other (hardware and/or software) components of systems.

As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

Provided are improved systems, devices, products, apparatus, and/or methods for active learning in graph neural networks through hybrid uncertainty reduction that (i) obtain a graph including a plurality of edges and a plurality of nodes for the plurality of edges, wherein each labeled node of a subset of labeled nodes of the plurality of nodes is associated with a label, and wherein each unlabeled node of a subset of unlabeled nodes of the plurality of nodes is not associated with a label; (ii) train, using the graph and the label for each labeled node of the subset of labeled nodes, a graph neural network (GNN), wherein training the GNN generates a prediction for each node of the plurality of nodes; (iii) generate, from the subset of unlabeled nodes, a candidate pool of candidate nodes; (iv) generate, using a label propagation algorithm, a predicted label for each candidate node of the candidate pool of candidate nodes; (v) select a candidate node of the candidate pool of candidate nodes that is associated with a greatest hybrid entropy reduction for the graph, wherein a current entropy of the graph is determined based on the prediction for each node of the plurality of nodes, wherein, for each candidate node of the candidate pool of candidate nodes, an updated entropy of the graph is determined based on the predicted label for that candidate node, and wherein, for each candidate node of the candidate pool of candidate nodes, a hybrid entropy reduction for the graph is determined as a difference between the current entropy of the graph and the updated entropy of the graph determined for that candidate node; (vi) provide the selected candidate node for labeling; (vii) receive a new label associated with the selected candidate node; (viii) add the selected candidate node to the subset of labeled nodes as a labeled node associated with the new label; and (ix) retrain, using the graph and the label for each labeled node of the subset of labeled nodes including the selected candidate node added to the subset of labeled nodes as a labeled node associated with the new label, the GNN, wherein retraining the GNN regenerates the prediction for each node of the plurality of nodes.

In this way, non-limiting embodiments or aspects of the present disclosure may provide active graph learning framework that improves or optimizes graph embedding performance by integrating a GNN and label propagation to actively assist the training oracle by estimating an impact of unlabeled nodes on graph performance improvement to enable selecting better nodes to query. For example, by using an input graph for which only a few nodes are labeled, a GNN may be trained on the current graph data to obtain the predicted embeddings of the GNN, and a graph entropy may be calculated to represent graph uncertainty. An unlabeled node that is most representative and/or valuable in improving the performance of the model may be identified from a candidate pool of candidate nodes by using label propagation to simulate the GNN and estimate training results of labeling the nodes in the candidate pool. Accordingly, a hybrid uncertainty reduction of labeling different candidate nodes may be obtained, and a node with a largest reduction may be added to the training set and the model may be retrained until a label budget is reached, thereby automatically filtering out insignificant nodes and reducing a computation cost and processing time for labeling.

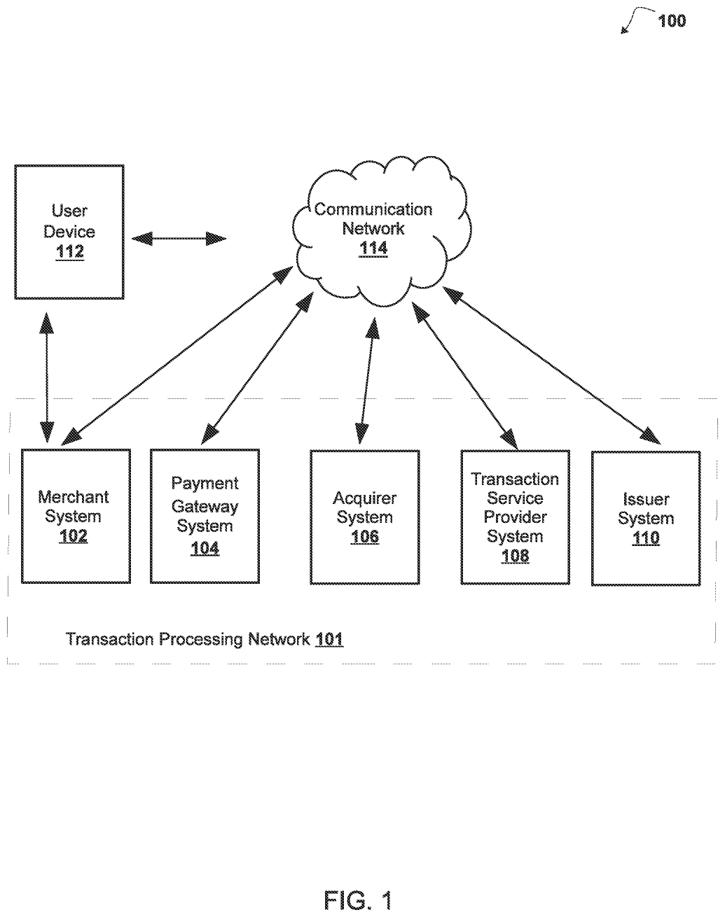

Referring now to FIG. 1, FIG. 1 is a diagram of an example environment 100 in which devices, systems, methods, and/or products described herein, may be implemented. As shown in FIG. 1, environment 100 includes transaction processing network 101, which may include merchant system 102, payment gateway system 104, acquirer system 106, transaction service provider system 108, issuer system 110, user device 112, and/or communication network 114. Transaction processing network 101, merchant system 102, payment gateway system 104, acquirer system 106, transaction service provider system 108, issuer system 110, and/or user device 112 may interconnect (e.g., establish a connection to communicate, etc.) via wired connections, wireless connections, or a combination of wired and wireless connections.

Merchant system 102 may include one or more devices capable of receiving information and/or data from payment gateway system 104, acquirer system 106, transaction service provider system 108, issuer system 110, and/or user device 112 via communication network 114 and/or communicating information and/or data to payment gateway system 104, acquirer system 106, transaction service provider system 108, issuer system 110, and/or user device 112 via communication network 114. Merchant system 102 may include a device capable of receiving information and/or data from user device 112 via a communication connection (e.g., an NFC communication connection, an RFID communication connection, a Bluetooth® communication connection, etc.) with user device 112, and/or communicating information and/or data to user device 112 via the communication connection. For example, merchant system 102 may include a computing device, such as a server, a group of servers, a client device, a group of client devices, and/or other like devices. In some non-limiting embodiments or aspects, merchant system 102 may be associated with a merchant as described herein. In some non-limiting embodiments or aspects, merchant system 102 may include one or more devices, such as computers, computer systems, and/or peripheral devices capable of being used by a merchant to conduct a payment transaction with a user. For example, merchant system 102 may include a POS device and/or a POS system.

Payment gateway system 104 may include one or more devices capable of receiving information and/or data from merchant system 102, acquirer system 106, transaction service provider system 108, issuer system 110, and/or user device 112 via communication network 114 and/or communicating information and/or data to merchant system 102, acquirer system 106, transaction service provider system 108, issuer system 110, and/or user device 112 via communication network 114. For example, payment gateway system 104 may include a computing device, such as a server, a group of servers, and/or other like devices. In some non-limiting embodiments or aspects, payment gateway system 104 is associated with a payment gateway as described herein.

Acquirer system 106 may include one or more devices capable of receiving information and/or data from merchant system 102, payment gateway system 104, transaction service provider system 108, issuer system 110, and/or user device 112 via communication network 114 and/or communicating information and/or data to merchant system 102, payment gateway system 104, transaction service provider system 108, issuer system 110, and/or user device 112 via communication network 114. For example, acquirer system 106 may include a computing device, such as a server, a group of servers, and/or other like devices. In some non-limiting embodiments or aspects, acquirer system 106 may be associated with an acquirer as described herein.

Transaction service provider system 108 may include one or more devices capable of receiving information and/or data from merchant system 102, payment gateway system 104, acquirer system 106, issuer system 110, and/or user device 112 via communication network 114 and/or communicating information and/or data to merchant system 102, payment gateway system 104, acquirer system 106, issuer system 110, and/or user device 112 via communication network 114. For example, transaction service provider system 108 may include a computing device, such as a server (e.g., a transaction processing server, etc.), a group of servers, and/or other like devices. In some non-limiting embodiments or aspects, transaction service provider system 108 may be associated with a transaction service provider as described herein. In some non-limiting embodiments or aspects, transaction service provider system 108 may include and/or access one or more internal and/or external databases including transaction data.

Issuer system 110 may include one or more devices capable of receiving information and/or data from merchant system 102, payment gateway system 104, acquirer system 106, transaction service provider system 108, and/or user device 112 via communication network 114 and/or communicating information and/or data to merchant system 102, payment gateway system 104, acquirer system 106, transaction service provider system 108, and/or user device 112 via communication network 114. For example, issuer system 110 may include a computing device, such as a server, a group of servers, and/or other like devices. In some non-limiting embodiments or aspects, issuer system 110 may be associated with an issuer institution as described herein. For example, issuer system 110 may be associated with an issuer institution that issued a payment account or instrument (e.g., a credit account, a debit account, a credit card, a debit card, etc.) to a user (e.g., a user associated with user device 112, etc.).

In some non-limiting embodiments or aspects, transaction processing network 101 includes a plurality of systems in a communication path for processing a transaction. For example, transaction processing network 101 can include merchant system 102, payment gateway system 104, acquirer system 106, transaction service provider system 108, and/or issuer system 110 in a communication path (e.g., a communication path, a communication channel, a communication network, etc.) for processing an electronic payment transaction. As an example, transaction processing network 101 can process (e.g., initiate, conduct, authorize, etc.) an electronic payment transaction via the communication path between merchant system 102, payment gateway system 104, acquirer system 106, transaction service provider system 108, and/or issuer system 110.

User device 112 may include one or more devices capable of receiving information and/or data from merchant system 102, payment gateway system 104, acquirer system 106, transaction service provider system 108, and/or issuer system 110 via communication network 114 and/or communicating information and/or data to merchant system 102, payment gateway system 104, acquirer system 106, transaction service provider system 108, and/or issuer system 110 via communication network 114. For example, user device 112 may include a client device and/or the like. In some non-limiting embodiments or aspects, user device 112 may be capable of receiving information (e.g., from merchant system 102, etc.) via a short range wireless communication connection (e.g., an NFC communication connection, an RFID communication connection, a Bluetooth® communication connection, and/or the like), and/or communicating information (e.g., to merchant system 102, etc.) via a short range wireless communication connection.

In some non-limiting embodiments or aspects, user device 112 may include one or more applications associated with user device 112, such as an application stored, installed, and/or executed on user device 112 (e.g., a mobile device application, a native application for a mobile device, a mobile cloud application for a mobile device, an electronic wallet application, a peer-to-peer payment transfer application, a merchant application, an issuer application, etc.).

Communication network 114 may include one or more wired and/or wireless networks. For example, communication network 114 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and systems shown in FIG. 1 is provided as an example. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. Additionally or alternatively, a set of devices and/or systems (e.g., one or more devices or systems) of environment 100 may perform one or more functions described as being performed by another set of devices and/or systems of environment 100.

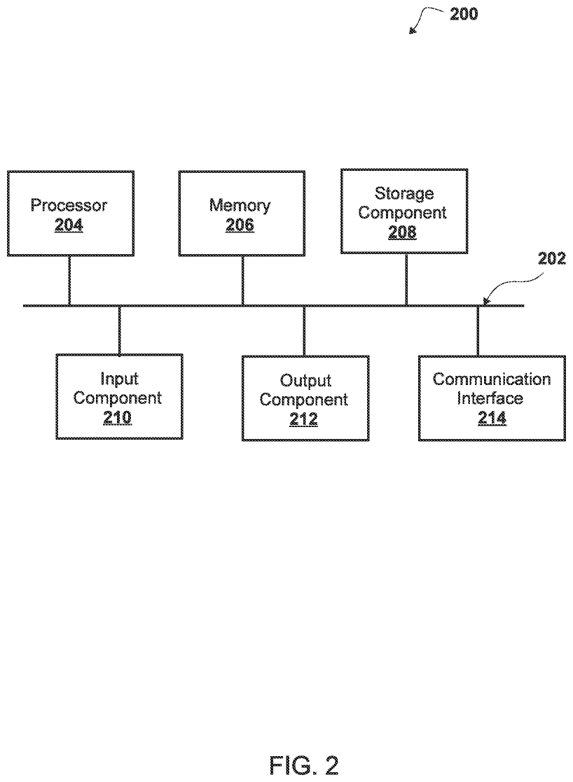

Referring now to FIG. 2, FIG. 2 is a diagram of example components of a device 200. Device 200 may correspond to one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.). In some non-limiting embodiments or aspects, one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.) may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

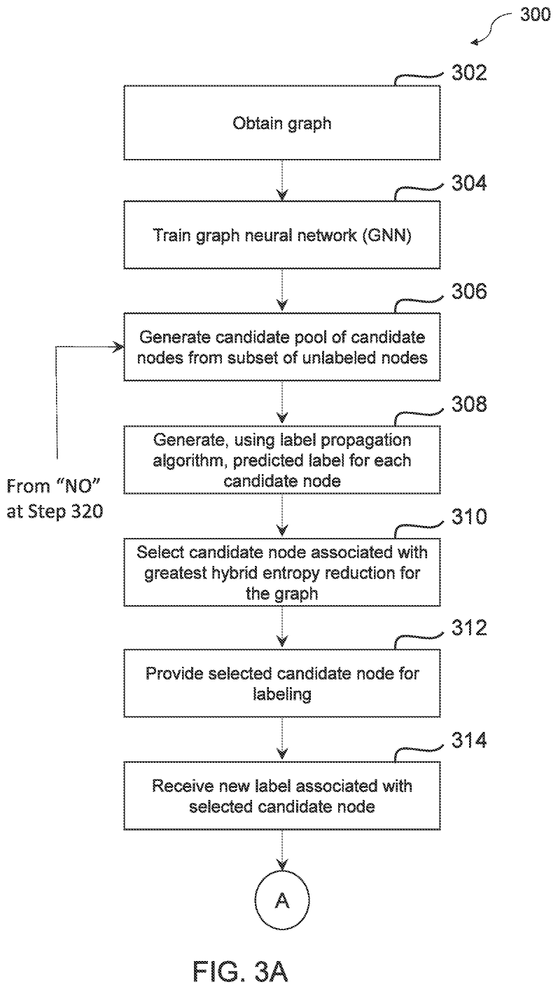

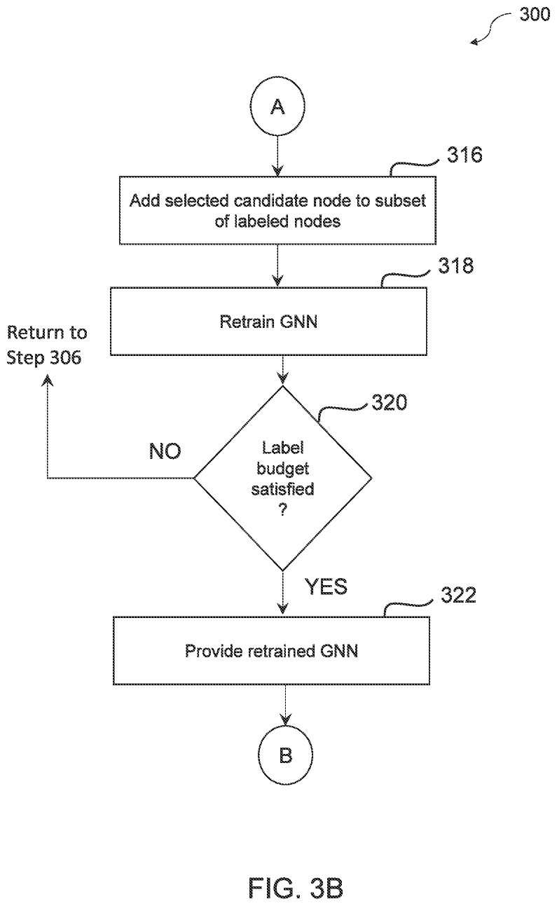

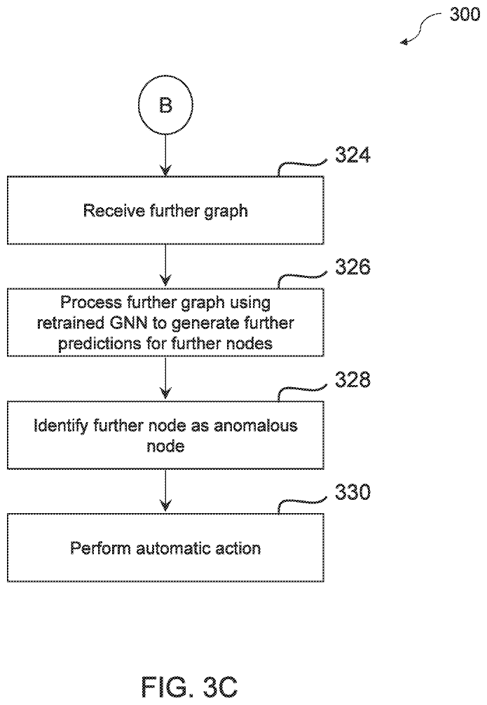

Referring now to FIGS. 3A-3C, FIGS. 3A-3C are flowcharts of non-limiting embodiments or aspects of a process 300 for active learning in graph neural networks through hybrid uncertainty reduction. In some non-limiting embodiments or aspects, one or more of the steps of process 300 may be performed (e.g., completely, partially, etc.) by transaction service provider system 108 (e.g., one or more devices of transaction service provider system 108). In some non-limiting embodiments or aspects, one or more of the steps of process 300 may be performed (e.g., completely, partially, etc.) by another device or a group of devices separate from or including transaction service provider system 108, such as, (e.g., one or more devices of merchant system 102), payment gateway system 104 (e.g., one or more devices of payment gateway system 104), acquirer system 106 (e.g., one or more devices of acquirer system 106), transaction service provider system 108 (e.g., one or more devices of transaction service provider system 108, etc.), issuer system 110 (e.g., one or more devices of issuer system 110), and/or user device 112.

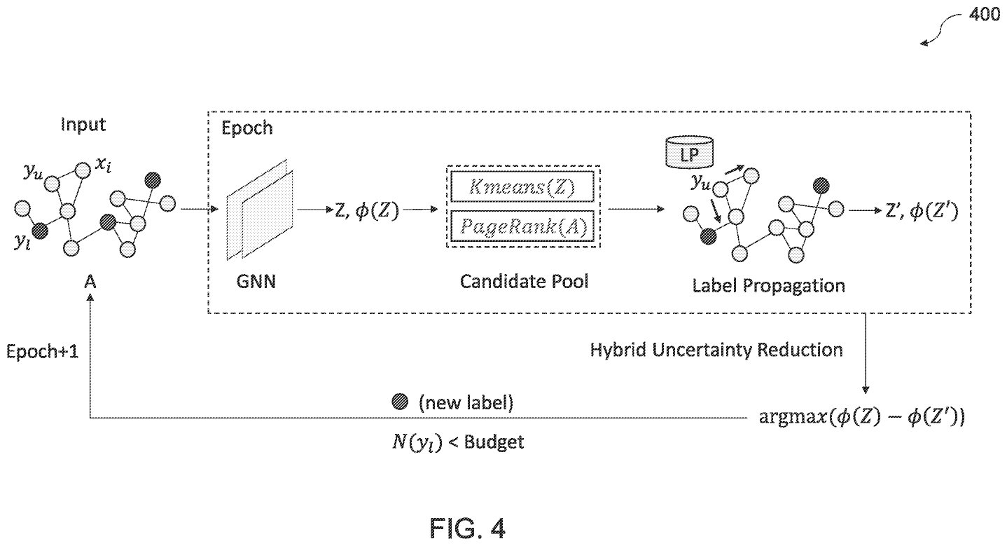

As shown in FIG. 3A, at step 302, process 300 includes obtaining a graph. For example, transaction service provider system 108 may obtain a graph, including a plurality of edges and a plurality of nodes for the plurality of edges. Each labeled node of a subset of labeled nodes of the plurality of nodes may be associated with a label. Each unlabeled node of a subset of unlabeled nodes of the plurality of nodes is not associated with a label. As an example, and referring also to FIG. 4, which is a diagram of an implementation 400 of non-limiting embodiments or aspects of a process for active learning in graph neural networks through hybrid uncertainty reduction, transaction service provider system 108 may initialize an input graph with only a subset of nodes xi being labeled y and the remainder of the nodes being unlabeled yᵤ, and the labeled nodes may be from different classes and/or may be randomly selected from a training set.

In some non-limiting embodiments or aspects, the plurality of nodes may be associated with a plurality of entities (e.g., entity attributes of the plurality of entities, etc.), and the plurality of edges may be associated with a plurality of relationships between the plurality of entities (e.g., between entities, between entities and entity attributes of the entities, etc.). In such an example, the plurality of nodes may include sets of independent entities and/or entity attributes, and the plurality of edges may include a set of sets of relations where each set of relations is the collection of all links of a specific link type that connects two fixed entity types. For example, the plurality of nodes may include entities of a plurality of different entity types and/or entity attributes of a plurality of different entity attribute types, and/or the plurality of edges may include edges of a plurality of different relation types. In some non-limiting embodiments or aspects, the plurality of nodes is associated with a plurality of merchants, and/or the plurality of edges is associated with a plurality of transactions between the plurality of merchants and/or between the plurality of merchants and a plurality of other entities also associated with the plurality of nodes (e.g., a plurality of customers, a plurality of issuers, etc.).

In some non-limiting embodiments or aspects, a label may be associated with one of a plurality of predetermined classes. For example, a label may be associated with and/or indicate that a node is an anomalous node (e.g., a merchant associated with a default and/or default risk, etc.) or a non-anomalous node (e.g., a merchant not associated with a default and/or default risk, etc.).

As shown in FIG. 3A, at step 304, process 300 includes training a graph neural network (GNN). For example, transaction service provider system 108 may train, using the graph and the label for each labeled node of the subset of labeled nodes, a GNN. In such an example, training the GNN may generate a prediction for each node of the plurality of nodes. As an example, and referring again to FIG. 4, transaction service provider system 108 may train a two-layer graph convolutional network (GCN) model to train on the input graph to perform a classification task, and the GCN model may incorporate information from the graph, such as an adjacency matrix, features, and/or training labels. Transaction service provider system 108 may obtain the predicted embeddings Z generated by the GNN and calculate a current graph entropy (Z) to represent the graph uncertainty.

In some non-limiting embodiments or aspects, the GNN may include a GCN (e.g., a two-layer GCN model, etc.).

Transaction service provider system 108 may train the GNN, using a semi-supervised learning technique, with node embeddings of the plurality of nodes and the labels for the subset of labeled nodes. Training the GNN may generate a plurality of predictions for the plurality of nodes. For example, transaction service provider system 108 may provide, as input, to the GNN, node embeddings of the plurality of nodes (e.g., node attributes, etc.), receive, as output, from the GNN, predictions for the nodes, and modify one or more parameters and/or weights of the GNN according to the semi-supervised learning technique that depends on the predictions and the labels.

In some non-limiting embodiments or aspects, a prediction includes a prediction of whether a node is an anomalous node (e.g., a merchant associated with a default and/or default risk, etc.) or a non-anomalous node (e.g., a merchant not associated with a default and/or default risk, etc.).

As shown in FIG. 3A, at step 306, process 300 includes generating a candidate pool of candidate nodes from a subset of unlabeled nodes. For example, transaction service provider system 108 may generate, from the subset of unlabeled nodes, a candidate pool of candidate nodes. As an example, and referring again to FIG. 4, transaction service provider system 108 may generate a candidate pool of candidate nodes by using K-means clustering and/or the PageRank algorithm to filter a percentage (e.g., 5%, etc.) of data points or nodes to identify density centers and graph centers, respectively, of the input graph.

In some non-limiting embodiments or aspects, transaction service provider system 108 may generate, from the subset of unlabeled nodes, the candidate pool of candidate nodes by at least one of the following: (i) clustering (e.g., using K-means clustering, etc.) the subset of unlabeled nodes into a plurality of clusters of unlabeled nodes and selecting, from each cluster of the plurality of clusters, for the candidate pool of candidate nodes, unlabeled nodes within a threshold distance of a center of that cluster; (ii) calculating (e.g., using the PageRank algorithm, etc.), based on the graph, a graph centrality of each unlabeled node of the subset of unlabeled nodes and selecting, for the candidate pool of candidate nodes, the unlabeled nodes associated with a graph centrality that satisfies a threshold graph centrality; (iii) generating, using the label propagation algorithm, the predicted label for each unlabeled node of the subset of unlabeled nodes, comparing, for each unlabeled node, the predicted label for that unlabeled node to the prediction for that node, and selecting, for the candidate pool of candidate nodes, the unlabeled nodes associated with a disagreement between the predicted label and the prediction; or any combination thereof.

As shown in FIG. 3A, at step 308, process 300 includes generating, using a label propagation algorithm, a predicted label for each candidate node. For example, transaction service provider system 108 may generate, using a label propagation algorithm, a predicted label for each candidate node of the candidate pool of candidate nodes. As an example, and referring again to FIG. 4, transaction service provider system 108 may use the label propagation algorithm to simulate training of the GNN and generate predicted embeddings or labels Z thereof, and estimate an impact of labelling different candidate nodes on a model performance improvement of the GNN by calculating an updated graph entropy ϕ(Z′) with a designed hybrid uncertainty reduction ϕ(Z)−ϕ(Z′) for a particular candidate node being determined as a difference between the current entropy ϕ(Z) and the updated entropy ϕ(Z′). In such an example, the label propagation algorithm may use the label information Y from the graph without using the features or attribute information X thereof.

As shown in FIG. 3A, at step 310, process 300 includes selecting a candidate node associated with greatest hybrid entropy reduction for the graph. For example, transaction service provider system 108 may select a candidate node of the candidate pool of candidate nodes that is associated with a greatest hybrid entropy reduction for the graph. As an example, and referring again to FIG. 4, transaction service provider system 108 may select a candidate node of the candidate pool of candidate nodes that is associated with a greatest hybrid entropy reduction argmax(ϕ(Z)−ϕ(Z′)) for the graph.

As an example, transaction service provider system 108 may use label propagation to simulate GNN training and estimate the training results of labeling each of the “center” nodes to obtain an update graph entropy for determining a hybrid uncertainty reduction of labeling different candidate nodes, and selecting the one with largest reduction and adding it to the training set, and retraining the model, until the label budget is reached.

In such an example, a current entropy of the graph may be determined based on the prediction for each node of the plurality of nodes. For each candidate node of the candidate pool of candidate nodes, an updated entropy of the graph may be determined based on the predicted label for that candidate node. For each candidate node of the candidate pool of candidate nodes, a hybrid entropy reduction for the graph may be determined as a difference between the current entropy of the graph and the updated entropy of the graph determined for that candidate node.

For example, an entropy for an event X with n possible outcomes and probabilities p₁, . . . , pₙ (e.g., the current entropy H(G, Z, Yₗ) for the graph, the updated entropy for the graph H(LP(G, Z, y), etc.) may be defined according to the following Equation (1):

$$H ( X ) = H ( {p}_{1} , … , {p}_{n} ) = - {\sum }_{i = 1}^{n} {p}_{i} {log}_{2} {p}_{i} \qquad ( 1 )$$

Accordingly, a hybrid entropy reduction ΔH for the graph for a candidate node may be determined as ΔH=H(G, Z, Yl)−H(LP (G, Z, y)), and argmax(ΔH₁, ΔH₂, ΔH₃, . . . , ΔHₖ) may be used to select the candidate node associated with the greatest hybrid entropy reduction for the graph.

As shown in FIG. 3A, at step 312, process 300 includes providing a selected candidate node for labeling. For example, transaction service provider system 108 may provide the selected candidate node for training. As an example, and referring again to FIG. 4, transaction service provider system 108 may provide the selected candidate node for labeling by a human expert.

As shown in FIG. 3A, at step 314, process 300 includes receiving a new label associated with the selected candidate node. For example, transaction service provider system 108 may receive a new label associated with the selected candidate node. As an example, and referring again to FIG. 4, transaction service provider system 108 may receive, as user input, a new label associated with the selected candidate node.

As shown in FIG. 3B, at step 316, process 300 includes adding a selected candidate node to the subset of labeled nodes. For example, transaction service provider system 108 may add the selected candidate node to the subset of labeled nodes as a labeled node associated with the new label. In such an example, transaction service provider system 108 may remove the selected candidate node that was added to the subset of labeled nodes from the subset of unlabeled nodes.

As shown in FIG. 3B, at step 318, process 300 includes retraining the GNN. For example, transaction service provider system 108 may retrain, using the graph and the label for each labeled node of the subset of labeled nodes, including the selected candidate node added to the subset of labeled nodes as a labeled node associated with the new label, the GNN. In such an example, retraining the GNN may regenerate the prediction for each node of the plurality of nodes.

As shown in FIG. 3B, at step 320, process 300 includes determining whether a label budget is satisfied. For example, transaction service provider system 108 may determine whether a label budget is satisfied. As an example, transaction service provider system 108 may repeat steps 306 through 318 a budgeted number of times. In such an example, in response to determining that the label budget is not satisfied, processing may return to step 306 of process 300. In such an example, in response to determining that the label budget is satisfied, processing may proceed to step 322 of process 300. As an example, and referring again to FIG. 4, transaction service provider system 108 may repeat steps 306 through 318 as long as N(yₗ)<Budget.

As shown in FIG. 3B, at step 322, process 300 includes providing the retrained GNN. For example, transaction service provider system 108 may provide the retrained GNN. As an example, transaction service provider system 108 may store the retrained GNN in a memory and/or a database.

As shown in FIG. 3C, at step 324, process 300 includes receiving a further graph. For example, transaction service provider system 108 may receive a further graph, including a plurality of further edges and a plurality of further nodes for the plurality of further edges.

In some non-limiting embodiments or aspects, the plurality of further nodes may be associated with a plurality of further entities (e.g., entity attributes of the plurality of further entities, etc.), and the plurality of further edges may be associated with a plurality of further relationships between the plurality of further entities (e.g., between further entities, between further entities and entity attributes of the further entities, etc.). In such an example, the plurality of further nodes may include sets of independent entities and/or entity attributes, and the plurality of further edges may include a set of sets of relations where each set of relations is the collection of all links of a specific link type that connects two fixed entity types. For example, the plurality of further nodes may include entities of a plurality of different entity types and/or entity attributes of a plurality of different entity attribute types, and/or the plurality of further edges may include edges of a plurality of different relation types. In some non-limiting embodiments or aspects, the plurality of further nodes is associated with a plurality of merchants, and/or the plurality of further edges is associated with a plurality of transactions between the plurality of merchants and/or between the plurality of merchants and a plurality of other entities also associated with the plurality of further nodes (e.g., a plurality of customers, a plurality of issuers, etc.).

As shown in FIG. 3C, at step 326, process 300 includes processing the further graph using the retrained GNN. For example, transaction service provider system 108 may process, using the retrained GNN, the further graph by providing, as input to the GNN, the further graph, and receiving, as output from the GNN, a further prediction (e.g., a further predicted embedding, etc.) for each further node of the plurality of further nodes.

As shown in FIG. 3C, at step 328, process 300 includes identifying a further node as an anomalous node. For example, transaction service provider system 108 may identify, based on the further prediction for each further node of the plurality of further nodes, a further node of the plurality of further nodes as an anomalous node.

As shown in FIG. 3C, at step 330, process 300 includes performing an automatic action. For example, in response to identifying the further node as an anomalous node, transaction service provider system 108 may perform an automatic action. As an example, in response to identifying the merchant as a default risk, transaction service provider system 108 may comprise at least one of: (i) automatically transmit information associated with an account of the merchant to a database to flag the account as associated with the default risk, (ii) automatically suspend processing of a transaction associated with the merchant in a transaction processing network by canceling the transaction, or (iii) automatically suspend access of the account of the merchant to a transaction service provider system in the transaction processing network.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
(i) obtaining, with at least one processor, a graph including a plurality of edges and a plurality of nodes for the plurality of edges, wherein each labeled node of a subset of labeled nodes of the plurality of nodes is associated with a label, and wherein each unlabeled node of a subset of unlabeled nodes of the plurality of nodes is not associated with a label;
(ii) training, with the at least one processor, using the graph and the label for each labeled node of the subset of labeled nodes, a graph neural network (GNN), wherein training the GNN generates a prediction for each node of the plurality of nodes;
(iii) generating, with the at least one processor, from the subset of unlabeled nodes, a candidate pool of candidate nodes;
(iv) generating, with the at least one processor, using a label propagation algorithm, a predicted label for each candidate node of the candidate pool of candidate nodes;
(v) selecting, with the at least one processor, a candidate node of the candidate pool of candidate nodes that is associated with a greatest hybrid entropy reduction for the graph, wherein a current entropy of the graph is determined based on the prediction for each node of the plurality of nodes, wherein, for each candidate node of the candidate pool of candidate nodes, an updated entropy of the graph is determined based on the predicted label for that candidate node, and wherein, for each candidate node of the candidate pool of candidate nodes, a hybrid entropy reduction for the graph is determined as a difference between the current entropy of the graph and the updated entropy of the graph determined for that candidate node;
(vi) providing, with the at least one processor, the selected candidate node for labeling;
(vii) receiving, with the at least one processor, a new label associated with the selected candidate node;
(viii) adding, with the at least one processor, the selected candidate node to the subset of labeled nodes as a labeled node associated with the new label; and
(ix) retraining, with the at least one processor, using the graph and the label for each labeled node of the subset of labeled nodes, including the selected candidate node added to the subset of labeled nodes as a labeled node associated with the new label, the GNN, wherein retraining the GNN regenerates the prediction for each node of the plurality of nodes.

2. The computer-implemented method of claim 1, further comprising:
repeating, with the at least one processor, steps (iii)-(ix) a budgeted number of times.

3. The computer-implemented method of claim 2, further comprising:
after repeating the steps (iii)-(ix) the budgeted number of times, providing the retrained GNN;
receiving, with the at least one processor, a further graph, including a plurality of further edges and a plurality of further nodes for the plurality of further edges;
processing, with the at least one processor, using the retrained GNN, the further graph by providing, as input to the GNN, the further graph, and receiving, as output from the GNN, a further prediction for each further node of the plurality of further nodes; and
identifying, with the at least one processor, based on the further prediction for each further node of the plurality of further nodes, a further node of the plurality of further nodes as an anomalous node.

4. The computer-implemented method of claim 3, wherein the plurality of further nodes is associated with a plurality of merchants, and wherein a merchant associated with the further node is identified as a default risk.

5. The computer-implemented method of claim 4, further comprising:
in response to identifying the merchant as a default risk, at least one of: (i) automatically transmitting, with the at least one processor, information associated with an account of the merchant to a database to flag the account as associated with the default risk; (ii) automatically suspending, with the at least one processor, processing of a transaction associated with the merchant in a transaction processing network by canceling the transaction; (iii) automatically suspending, with the at least one processor, access of the account of the merchant to a transaction service provider system in the transaction processing network; or any combination thereof.

6. The computer-implemented method of claim 1, wherein generating, from the subset of unlabeled nodes, the candidate pool of candidate nodes includes at least one of the following:
(i) clustering the subset of unlabeled nodes into a plurality of clusters of unlabeled nodes and selecting, from each cluster of the plurality of clusters, for the candidate pool of candidate nodes, unlabeled nodes within a threshold distance of a center of that cluster;
(ii) calculating, based on the graph, a graph centrality of each unlabeled node of the subset of unlabeled nodes and selecting, for the candidate pool of candidate nodes, the unlabeled nodes associated with a graph centrality that satisfies a threshold graph centrality;
(iii) generating, using the label propagation algorithm, the predicted label for each unlabeled node of the subset of unlabeled nodes, comparing, for each unlabeled node, the predicted label for that unlabeled node to the prediction for that node, and selecting, for the candidate pool of candidate nodes, the unlabeled nodes associated with a disagreement between the predicted label and the prediction; or
any combination thereof.

7. The computer-implemented method of claim 1, wherein the GNN includes a graph convolutional network (GCN).

8. A system, comprising:
at least one processor programmed and/or configured to:
(i) obtain a graph including a plurality of edges and a plurality of nodes for the plurality of edges, wherein each labeled node of a subset of labeled nodes of the plurality of nodes is associated with a label, and wherein each unlabeled node of a subset of unlabeled nodes of the plurality of nodes is not associated with a label;
(ii) train, using the graph and the label for each labeled node of the subset of labeled nodes, a graph neural network (GNN), wherein training the GNN generates a prediction for each node of the plurality of nodes;
(iii) generate, from the subset of unlabeled nodes, a candidate pool of candidate nodes;
(iv) generate, using a label propagation algorithm, a predicted label for each candidate node of the candidate pool of candidate nodes;
(v) select a candidate node of the candidate pool of candidate nodes that is associated with a greatest hybrid entropy reduction for the graph, wherein a current entropy of the graph is determined based on the prediction for each node of the plurality of nodes, wherein, for each candidate node of the candidate pool of candidate nodes, an updated entropy of the graph is determined based on the predicted label for that candidate node, and wherein, for each candidate node of the candidate pool of candidate nodes, a hybrid entropy reduction for the graph is determined as a difference between the current entropy of the graph and the updated entropy of the graph determined for that candidate node;
(vi) provide the selected candidate node for labeling;
(vii) receive a new label associated with the selected candidate node;
(viii) add the selected candidate node to the subset of labeled nodes as a labeled node associated with the new label; and
(ix) retrain, using the graph and the label for each labeled node of the subset of labeled nodes, including the selected candidate node added to the subset of labeled nodes as a labeled node associated with the new label, the GNN, wherein retraining the GNN regenerates the prediction for each node of the plurality of nodes.

9. The system of claim 8, wherein the at least one processor is further programmed and/or configured to:
repeat steps (iii)-(ix) a budgeted number of times.

10. The system of claim 9, wherein the at least one processor is further programmed and/or configured to:
after repeating the steps (iii)-(ix) the budgeted number of times, provide the retrained GNN;
receive a further graph including a plurality of further edges and a plurality of further nodes for the plurality of further edges;
process, using the retrained GNN, the further graph by providing, as input to the GNN, the further graph, and receiving, as output from the GNN, a further prediction for each further node of the plurality of further nodes; and
identify, based on the further prediction for each further node of the plurality of further nodes, a further node of the plurality of further nodes as an anomalous node.

11. The system of claim 10, wherein the plurality of further nodes is associated with a plurality of merchants, and wherein a merchant associated with the further node is identified as a default risk.

12. The system of claim 11, wherein the at least one processor is further programmed and/or configured to:
in response to identifying the merchant as a default risk, at least one of: (i) automatically transmit information associated with an account of the merchant to a database to flag the account as associated with the default risk; (ii) automatically suspend processing of a transaction associated with the merchant in a transaction processing network by canceling the transaction; (iii) automatically suspend access of the account of the merchant to a transaction service provider system in the transaction processing network; or any combination thereof.

13. The system of claim 8, wherein the at least one processor is programmed and/or configured to generate, from the subset of unlabeled nodes, the candidate pool of candidate nodes by at least one of the following:
(i) clustering the subset of unlabeled nodes into a plurality of clusters of unlabeled nodes and selecting, from each cluster of the plurality of clusters, for the candidate pool of candidate nodes, unlabeled nodes within a threshold distance of a center of that cluster;
(ii) calculating, based on the graph, a graph centrality of each unlabeled node of the subset of unlabeled nodes and selecting, for the candidate pool of candidate nodes, the unlabeled nodes associated with a graph centrality that satisfies a threshold graph centrality;
(iii) generating, using the label propagation algorithm, the predicted label for each unlabeled node of the subset of unlabeled nodes, comparing, for each unlabeled node, the predicted label for that unlabeled node to the prediction for that node, and selecting, for the candidate pool of candidate nodes, the unlabeled nodes associated with a disagreement between the predicted label and the prediction; or
any combination thereof.

14. The system of claim 8, wherein the GNN includes a graph convolutional network (GCN).

15. A computer program product comprising at least one non-transitory computer-readable medium including program instructions that, when executed by at least one processor, cause the at least one processor to:
(i) obtain a graph including a plurality of edges and a plurality of nodes for the plurality of edges, wherein each labeled node of a subset of labeled nodes of the plurality of nodes is associated with a label, and wherein each unlabeled node of a subset of unlabeled nodes of the plurality of nodes is not associated with a label;
(ii) train, using the graph and the label for each labeled node of the subset of labeled nodes, a graph neural network (GNN), wherein training the GNN generates a prediction for each node of the plurality of nodes;
(iii) generate, from the subset of unlabeled nodes, a candidate pool of candidate nodes;
(iv) generate, using a label propagation algorithm, a predicted label for each candidate node of the candidate pool of candidate nodes;
(v) select a candidate node of the candidate pool of candidate nodes that is associated with a greatest hybrid entropy reduction for the graph, wherein a current entropy of the graph is determined based on the prediction for each node of the plurality of nodes, wherein, for each candidate node of the candidate pool of candidate nodes, an updated entropy of the graph is determined based on the predicted label for that candidate node, and wherein, for each candidate node of the candidate pool of candidate nodes, a hybrid entropy reduction for the graph is determined as a difference between the current entropy of the graph and the updated entropy of the graph determined for that candidate node;
(vi) provide the selected candidate node for labeling;
(vii) receive a new label associated with the selected candidate node;
(viii) add the selected candidate node to the subset of labeled nodes as a labeled node associated with the new label; and
(ix) retrain, using the graph and the label for each labeled node of the subset of labeled nodes, including the selected candidate node added to the subset of labeled nodes as a labeled node associated with the new label, the GNN, wherein retraining the GNN regenerates the prediction for each node of the plurality of nodes.

16. The computer program product of claim 15, wherein the program instructions, when executed by the at least one processor, further cause the at least one processor to:
repeat steps (iii)-(ix) a budgeted number of times.

17. The computer program product of claim 16, wherein the program instructions, when executed by the at least one processor, further cause the at least one processor to:
after repeating the steps (iii)-(ix) the budgeted number of times, provide the retrained GNN;
receive a further graph including a plurality of further edges and a plurality of further nodes for the plurality of further edges;
process, using the retrained GNN, the further graph by providing, as input to the GNN, the further graph, and receiving, as output from the GNN, a further prediction for each further node of the plurality of further nodes; and
identify, based on the further prediction for each further node of the plurality of further nodes, a further node of the plurality of further nodes as an anomalous node.

18. The computer program product of claim 17, wherein the plurality of further nodes is associated with a plurality of merchants, and wherein a merchant associated with the further node is identified as a default risk.

19. The computer program product of claim 18, wherein the program instructions, when executed by the at least one processor, further cause the at least one processor to:
in response to identifying the merchant as a default risk, at least one of: (i) automatically transmit information associated with an account of the merchant to a database to flag the account as associated with the default risk; (ii) automatically suspend processing of a transaction associated with the merchant in a transaction processing network by canceling the transaction; (iii) automatically suspend access of the account of the merchant to a transaction service provider system in the transaction processing network; or any combination thereof.

20. The computer program product of claim 15, wherein the program instructions, when executed by the at least one processor, cause the at least one processor to generate, from the subset of unlabeled nodes, the candidate pool of candidate nodes by at least one of the following:
(i) clustering the subset of unlabeled nodes into a plurality of clusters of unlabeled nodes and selecting, from each cluster of the plurality of clusters, for the candidate pool of candidate nodes, unlabeled nodes within a threshold distance of a center of that cluster;
(ii) calculating, based on the graph, a graph centrality of each unlabeled node of the subset of unlabeled nodes and selecting, for the candidate pool of candidate nodes, the unlabeled nodes associated with a graph centrality that satisfies a threshold graph centrality;
(iii) generating, using the label propagation algorithm, the predicted label for each unlabeled node of the subset of unlabeled nodes, comparing, for each unlabeled node, the predicted label for that unlabeled node to the prediction for that node, and selecting, for the candidate pool of candidate nodes, the unlabeled nodes associated with a disagreement between the predicted label and the prediction; or
any combination thereof.
